(19) United States
(12) Patent Application Publication
(10) Pub. No.: US 2004/0266983 A1
(43) Pub. Date: Dec. 30, 2004

(54) Purified polyoxyalkylene block copolymers

(76) Inventors: Lorraine E. Reeve, Dexter, MI (US); Michael G. Hinsberg, Troy, MI (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/811,239

(22) Filed: Mar. 26, 2004

Related U.S. Application Data
(63) Continuation-in-part of application No. 10/766,756, filed on Jan. 28, 2004.
Application No. 10/766,756 is a continuation of application No. 09/928,560, filed on Aug. 13, 2001, now Pat. No. 6,761,824.
(60) Provisional application No. 60/225,917, filed on Aug. 17, 2000.

(51) Int. Cl. C08G 65/04

(52) U.S. Cl. 528/421

(57) ABSTRACT

The present invention relates to fractionated block copolymers characterized by a higher average molecular weight, a narrower molecular weight distribution and decreased unsaturation compared to the unfractionated polymers. The polyoxyalkylene block copolymers exhibited higher viscosities, a liquid to gel transition at lower temperatures and a liquid to gel transition over a narrower temperature range than unfractionated polyoxyalkylene block copolymers at the same concentration. One specific aspect of the invention relates to a polyoxyalkylene block copolymer, wherein the polyoxyalkylene block copolymer transforms from a liquid to a gel over a temperature range of about 2° C. to about 5° C. Another specific aspect relates to a polyoxyalkylene block copolymer, wherein the viscosity of an aqueous solution of the polyoxyalkylene block copolymer increases by at least a factor of two over a temperature range of about 2° C.

### RELATED APPLICATION INFORMATION

This application is a continuation-in-part of U.S. patent application Ser. No. 10/766,756, filed Jan. 28, 2004; which is a continuation of U.S. patent application Ser. No. 09/928,560, filed Aug. 13, 2001; which claims the benefit of U.S. Provisional Application Ser. No. 60/225,917, filed Aug. 17, 2000. All three applications are hereby incorporated in their entirety.

### BACKGROUND OF THE INVENTION

Methods have been described for separating polymers of similar composition and structure. See, e.g., U.S. Pat. Nos.: 5,028,336; 5,116,508; 5,523,492; 5,567,859; 5,696,298; 5,800,711; and Published PCT Patent Applications WO 92/16484; WO 98/29459; WO 99/20683; and WO 01/40321; all of which are incorporated herein by reference. Also, various procedures have been described to fractionate proteins and peptides, but most of them include a precipitation step using ammonium sulfate (Englard, S., and Seifter, S., 1990, Chapter 22: Precipitation Techniques, Methods in Enzymology, 182, 285-300). This method relies on the fact that proteins, in an aqueous solution, maintain a tertiary structure based on their amino acid composition and various bonds within the molecule. The tertiary structure generally allows the hydrophobic sidechains to be sequestered inside the molecule and the hydrophilic sidechains to be on the surface, i.e., in contact with the aqueous environment. Changes in the ionic strength of the aqueous solution cause unfolding of the folded protein; as the hydrophobic substituents are exposed to the aqueous environment, the solubility of the protein decreases, resulting in precipitation. By carefully adjusting the pH, ionic strength, and/or temperature, it is sometimes possible to separate proteins with similar amino acid sequences (Englard, S., and Seifter, S., 1990, Chapter 22: Precipitation Techniques, Methods in Enzymology, 182, 285-300; King, T. P., Biochemistry, 1972, 11(3), 367-371; Tarli, P., and Li, C. H., Archives Biochemistry and Biophysics, 1974, 161, 696-697). Clearly, this method is useful only for proteins and other polymers composed of substituents that vary considerably in polarity, and, therefore, aqueous solubility. This difference, however, is uncommon among synthetic polymers.

A method to separate water-soluble organic electrolytes in an aqueous medium from other water-soluble hydrocarbons has been disclosed (U.S. Pat. No. 5,028,336). The pH of the aqueous medium is adjusted so that most of the organic electrolytes to be isolated are charged. The aqueous medium is then passed through a filtration membrane carrying the same charge. The organic electrolytes are repelled by the charge on the membrane, precluding crossing. Water and uncharged organic molecules pass through the membrane and are thus separated from the organic electrolytes. This method is limited to organic molecules, such as carboxylic acids, that contain functional groups capable of carrying a charge at some pH.

Various methods have been described for removing impurities from synthetic polymers. A method for purifying synthetic, ionic polymers using an ultrafiltration membrane is disclosed in Published PCT Patent Application WO 98/29459. A process for purifying a polymer using ultrasonic extraction is disclosed in Published PCT Patent Application WO 99/20683. According to this method, once separated, the impurities are removed by liquid/solid separation techniques, such as filtration, centrifugation, distillation, or membrane separation. Disclosed in Published PCT Patent Application WO 01/40321 is a method for purifying or fractionating polymers by dissolving them in alcohol, followed by extraction with one or more solvents that are immiscible with alcohol, and which will extract the impurities from the alcohol phase as well. Clearly, these methods are effective only if the polymer and the impurities differ sufficiently in size or polarity or both. Many synthetic polyol polymers, however, are not amenable to such techniques.

Methods relying on supercritical-fluid extraction have been developed to separate high-molecular-weight compounds, including polymers, from complex mixtures in aqueous solution (See, e.g., U.S. Pat. No. 5,116,508). This method requires a mobile phase of highly compressed gas, such as CO₂, at or above its critical temperature and pressure, to be pumped through the aqueous solution. The composition of the mobile phase can be modified to enhance extraction of the desired analyte. Such modifications include using a mixture of gases as the mobile phase, or adding a modifying chemical to the supercritical fluid. Such methods can be conducted on a commercial scale, and used to separate uncharged polymers including polyols. Nevertheless, to be effective, the compressed gases often must be maintained at high temperatures and pressures, requiring a relatively complex, controlled equipment. This requirement frequently makes supercritical fluid extraction an expensive process, limiting its commercial applications.

Synthetic polyols, such as poly(ethylene glycol) and polyoxyalkylene block copolymers, have been used in various medical and pharmaceutical applications, including treatment of sickle cell disease, reduction of blood viscosity, treatment of tissue ischemia, treatment of tissue following electrical injury, and drug delivery (U.S. Pat. Nos. 5,691,387; Re. 36,665; and 5,605,687). These linear polymers are generally synthesized by repeated sequential reactions that add monomeric subunits to each end of the polymeric chain. Since subunits may add to either or both ends of individual chains at variable rates, the end product is a mixture of molecules varying in molecular weight.

Poly(ethylene glycols) are composed of ethylene oxide residues linked by ether linkages and vary considerably in molecular weight. These synthetic polymers have been used extensively in drug delivery to solubilize pharmaceutically active compounds. Recently, they have been used to derivatize proteins, peptides and small molecules to prolong half-life and enhance delivery within the body. They have also been derivatized and used as cross-linking components in medical devices. For optimal safety and efficiency in medical applications, these recent uses will require polymers of uniform molecular weight having minimal contamination with reaction byproducts.

The poloxamers are polyoxyalkylene block copolymers composed of two polyoxyethylene blocks separated by a polyoxypropylene center block. In addition to poloxamer molecules of varying molecular weights, the commercially available poloxamers contain a mixture of polyoxyethylene homopolymer, and polyoxyethylene/polyoxypropylene di-block polymers. Consequently, the polymer product has a broad molecular-weight range, reflected in a high polydispersity index. The mono- and di-block polymers are generally of a lower molecular weight than the average for the polymer product and contain some unsaturation. When commercially available poloxamers (purchased from BASF Corp.) were analyzed by gel permeation chromatography, a bimodal molecular-weight distribution was observed (Reeve, L. E., “The Poloxamers: Their Chemistry and Medical Applications,” in Handbook of Biodegradable Polymers, 1997, 231-249, editors Domb, Kost, and Wiseman, Harwood Academic Publishers). The mono- and di-block contaminants, including the unsaturated species, partitioned into the lower-molecular-weight fraction.

Published PCT Patent Application WO 92/16484 and U.S. Pat. No. 5,990,241 disclose the use of gel-permeation chromatography to isolate a fraction of poloxamer 188 that exhibits improved biological effects, without causing potentially deleterious side effects. The copolymer thus obtained had a polydispersity of 1.07 or less, and was substantially saturated. The potentially harmful side effects were shown to be associated with the low-molecular-weight, unsaturated portion of the polymer, while the medically-beneficial effects resided in the uniform higher-molecular-weight material. Other similarly improved copolymers were obtained by purifying either the polyoxypropylene center block during synthesis of the copolymer, or the copolymer product itself (U.S. Pat. Nos. 5,523,492; 5,696,298). Although an effective means of purification, gel-permeation chromatography is impractical for the preparation of large quantities of the fractionated polyoxyalkylene block copolymer.

A supercritical-fluid extraction technique has been used to fractionate a polyoxyalkylene block copolymer as disclosed in U.S. Pat. No. 5,567,859. A purified fraction was obtained, which was composed of a fairly uniform polyoxyalkylene block copolymer having a polydispersity index of less than 1.17. According to this method, the lower-molecular-weight fraction was removed in a stream of CO₂ maintained at a pressure of 2200 pounds per square inch (psi) and a temperature of 40° C. As is frequently the case, this supercritical-fluid extraction method required equipment that can control temperature and accommodate compressed CO₂ at high pressure. Clearly, these requirements add expense to the procedure and will likely limit its commercial value.

U.S. Pat. No. 5,800,711 discloses a process for the fractionation of polyoxyalkylene block copolymers by the batchwise removal of low-molecular-weight species using a salt extraction and liquid-phase separation technique. Poloxamers 407 and 188 were fractionated by this method. In each case, a copolymer fraction was obtained which had a higher average molecular weight and a lower polydispersity index as compared to the starting material. However, the changes in polydispersity index were modest and analysis by gel permeation chromatography indicated that some low-molecular-weight material remained. The viscosity of aqueous solutions of the fractionated polymers was significantly greater than the viscosity of the commercially available polymers at temperatures between 10° C. and 37° C., an important property for some medical and drug-delivery applications. Nevertheless, some of the low-molecular-weight contaminants of these polymers are thought to cause deleterious side effects when used in the body, making it important to remove them in the fractionation process. As a consequence, polyoxyalkylene block copolymers fractionated by this process are not appropriate for some medical uses.

Aqueous two-phase systems have been used to concentrate or isolate polymers, other large molecules, and even particles from complex mixtures (Hatti-Kaul, R., “Aqueous Two-Phase Systems, Methods and Protocols,” 2000, Humana Press). Such systems generally avoid the use of organic solvents, and extremes of pH or temperature; because of their mild conditions, these systems are useful for isolating peptides, proteins, plasma membranes including membrane vesicles, and viruses. These systems are composed of either hydrophilic polymer pairs or a polymer and a salt that are incompatible in aqueous solution and form two phases in equilibrium. Separations can be carried out using either batch procedures or counter-current fluid distribution. Although widely used for the isolation and purification of biomaterials, aqueous two-phase systems have not been used for the isolation or fractionation of non-peptidic synthetic polymers.

### SUMMARY OF THE INVENTION

In one embodiment, the present invention relates to substantially pure polyoxyalkylene block copolymer, wherein the polyoxyalkylene block copolymer transforms from a liquid to a gel over a temperature range of about 2° C. to about 5° C. In a further embodiment, the polyoxyalkylene block copolymer transforms from a liquid to a gel over a temperature range of about 2° C. to about 3° C. In a further embodiment, the polyoxyalkylene block copolymer transforms from a liquid to a gel over a temperature range of about 2° C. In a further embodiment, the polyoxyalkylene block copolymer transforms from a liquid to a gel below about 37° C.

In a further embodiment, the present invention relates to any of the polyoxyalkylene block copolymers described above, wherein the polyoxyalkylene block copolymer has an average molecular weight of about 3,000 daltons to about 100,000 daltons. In a further embodiment, the present invention relates to any of the polyoxyalkylene block copolymers described above, wherein the polyoxyalkylene block copolymer is selected from the group consisting of poloxamers and poloxamines. In a further embodiment, the present invention relates to any of the polyoxyalkylene block copolymers described above, wherein the polyoxyalkylene block copolymer is a poloxamer. In a further embodiment, the present invention relates to any of the polyoxyalkylene block copolymers described above, wherein the polyoxyalkylene block copolymer is a poloxamine.

In another embodiment, the present invention relates to a substantially pure polyoxyalkylene block copolymer, wherein the viscosity of an aqueous solution of the polyoxyalkylene block copolymer increases by at least a factor of two over a temperature range of about 2° C. In a further embodiment, the polyoxyalkylene block copolymer has an average molecular weight of about 3,000 daltons to about 100,000 daltons. In a further embodiment, the polyoxyalkylene block copolymer is selected from the group consisting of poloxamers and poloxamines. In a further embodiment, the polyoxyalkylene block copolymer is a poloxamer. In a further embodiment, the polyoxyalkylene block copolymer is a poloxamine.

In another embodiment, the present invention relates to a composition, comprising a polyoxyalkylene block copolymer that transforms from a liquid to a gel over a temperature range of about 2° C. to about 5° C., and/or a polyoxyalkylene block copolymer where the viscosity of an aqueous solution of the polyoxyalkylene block copolymer increases by at least a factor of two over a temperature range of about 2° C.; and a therapeutic agent.

In a further embodiment, the present invention relates to a kit comprising a polyoxyalkylene block copolymer that transforms from a liquid to a gel over a temperature range of about 2° C. to about 5° C., and/or a polyoxyalkylene block copolymer where the viscosity of an aqueous solution of the polyoxyalkylene block copolymer increases by at least a factor of two over a temperature range of about 2° C.

### BRIEF DESCRIPTION OF THE DRAWINGS

FIG. 1a depicts the viscosities of various concentrations of fractionated poloxamer 338 as a function of temperature.

FIG. 1b depicts the viscosities of various concentrations of unfractionated polxamer 338 as a function of temperature.

FIG. 1c depicts the viscosities of fractionated and unfractionated poloxamer 338 as a function of temperature (17.5% w/w aqueous solution).

FIG. 2a depicts a chromatogram of poloxamer 407 showing the molecular weight distribution of the polymer before and after fractionation a method of the present invention.

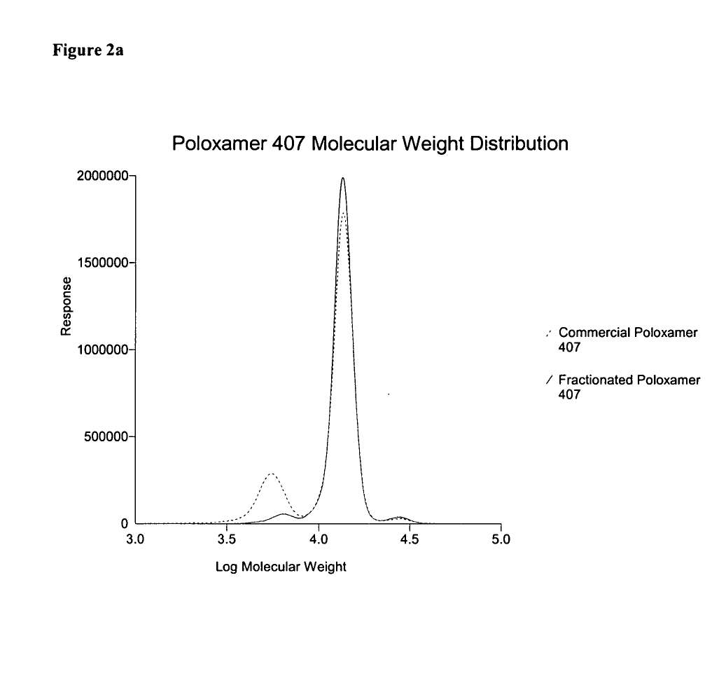

FIG. 2b depicts as a function of temperature the viscosities of 25% w/w aqueous solutions of commercially available poloxamer 407 and fractionated poloxamer 407 obtained using a method of the present invention.

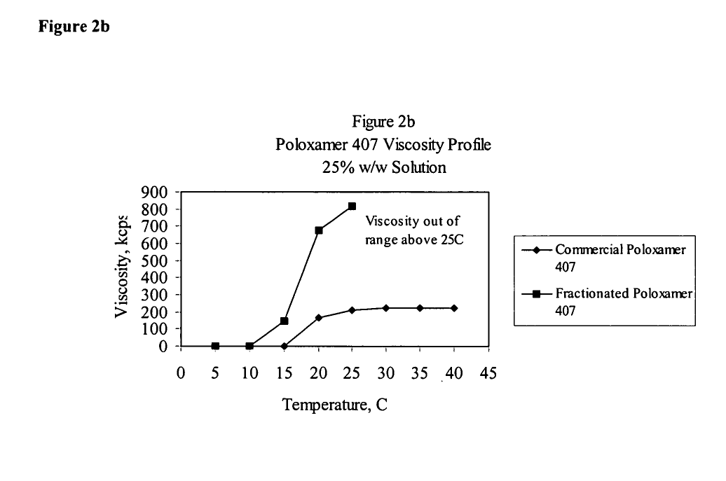

FIG. 3a depicts a chromatogram of poloxamer 188 showing the molecular weight distribution of the polymer before and after fractionation using a method of the present invention.

FIG. 3b depicts as a function of temperature the viscosities of 35% w/w aqueous solutions of commercially available poloxamer 188 and fractionated poloxamer 188 obtained using a method of the present invention.

FIG. 4 depicts the viscosities of fractionated and unfractionated poloxamer 288 as a function of temperature (17.5% w/w aqueous solution).

FIG. 5a depicts a chromatogram of poloxamine 1307 showing the molecular weight distribution of the polymer before and after fractionation using a method of the present invention.

FIG. 5b depicts as a function of temperature the viscosities of 25% w/w aqueous solutions of commercially available poloxamine 1307 and fractionated poloxamine 1307 obtained using a method of the present invention.

FIG. 6 depicts the viscosities of 17.5% w/w aqueous solutions of fractionated and unfractionated poloxamine 1107 as a function of temperature.

### DETAILED DESCRIPTION OF THE INVENTION

Definitions

For convenience, before further description of the present invention, certain terms employed in the specification, examples, and appended claims are collected here. These definitions should be read in light of the remainder of the disclosure and understood as by a person of skill in the art.

The articles “a” and “an” are used herein to refer to one or more than one (i.e., at least one) of the grammatical object of the article. By way of example, “an element” means one element or more than one element.

When used with respect to a therapeutic agent or other material, the term “sustained release” is art-recognized. For example, a subject composition which releases a substance over time may exhibit sustained release characteristics, in contrast to a bolus type administration in which the entire amount of the substance is made biologically available at one time.

The term “poloxamer” denotes a symmetrical block copolymer, consisting of a core of PPG polyoxyethylated to both its terminal hydroxyl groups, i.e. conforming to the interchangable generic formula (PEG)_{X}—(PPG)_{Y}—(PEG)_{X} and (PEO)_{X}—(PPO)_{Y}—(PEO)_{X}. Each poloxamer name ends with an arbitrary code number, which is related to the average numerical values of the respective monomer units denoted by X and Y.

The term “poloxamine” denotes a polyalkoxylated symmetrical block copolymer of ethylene diamine conforming to the general type [(PEG)_{X}—(PPG)_{Y}]₂—NCH₂CH₂N—[(PPG)_{Y}—(PEG)_{X}]₂. Each Poloxamine name is followed by an arbitrary code number, which is related to the average numerical values of the respective monomer units denoted by X and Y.

The term “inverse thermosensitive polymer” as used herein refers to a polymer that is soluble in water at ambient temperature, but at least partially phase-separates out of water at physiological temperature. Inverse thermosensitive polymers include poloxamer 407, poloxamer 188, Pluronic® F127, Pluronic® F68, poly(N-isopropylacrylamide), poly(methyl vinyl ether), poly(N-vinylcaprolactam); and certain poly(organophosphazenes). See Bull. Korean Chem. Soc. 2002, 23, 549-554.

The phrase “polydispersity index” refers to the ratio of the “weight average molecular weight” to the “number average molecular weight” for a particular polymer; it reflects the distribution of individual molecular weights in a polymer sample.

The phrase “weight average molecular weight” refers to a particular measure of the molecular weight of a polymer. The weight average molecular weight is calculated as follows: determine the molecular weight of a number of polymer molecules; add the squares of these weights; and then divide by the total weight of the molecules.

The phrase “number average molecular weight” refers to a particular measure of the molecular weight of a polymer. The number average molecular weight is the common average of the molecular weights of the individual polymer molecules. It is determined by measuring the molecular weight of n polymer molecules, summing the weights, and dividing by n.

A comprehensive list of the abbreviations utilized by organic chemists of ordinary skill in the art appears in the first issue of each volume of the Journal of Organic Chemistry; this list is typically presented in a table entitled Standard List of Abbreviations.

For purposes of this invention, the chemical elements are identified in accordance with the Periodic Table of the Elements, CAS version, Handbook of Chemistry and Physics, 67th Ed., 1986-87, inside cover.

Contemplated equivalents of the polymers, subunits and other compositions described above include such materials which otherwise correspond thereto, and which have the same general properties thereof (e.g., biocompatible), wherein one or more simple variations of substituents are made which do not adversely affect the efficacy of such molecule to achieve its intended purpose. In general, the compounds of the present invention may be prepared by the methods illustrated in the general reaction schemes as, for example, described below, or by modifications thereof, using readily available starting materials, reagents and conventional synthesis procedures. In these reactions, it is also possible to make use of variants which are in themselves known, but are not mentioned here.

Polymer Properties

Although molecular-weight averages are informative when comparing polymers, it is also useful to know the molecular-weight distribution of each polymer. The polydispersity index of a polymer is a universally accepted measure of the breadth of the molecular-weight distribution. A low polydispersity value, D, indicates a narrow molecular weight distribution. In a monodisperse population where all molecules are identical, M_{w} would be equal to Mₙ and the polydispersity index would be equal to 1.0. Typical polymer preparations have polydispersity index values between 1.5 and 5, but some may be much higher.

A variety of procedures is available for determining molecular weight including gel-permeation chromatography or other chromatographic techniques, viscosity-related measurements, light scattering, osmotic pressure, ultra centrifugation and chemical methods involving end group analysis. For most polymers, molecular weight distribution parameters are conveniently measured using gel permeation chromatography.

The viscosity of a fluid is a measure of friction that results when one layer of the fluid moves in relation to another layer in response to a shearing force. The terms shear stress (τ) and rate of shear (Γ) are used to indicate the applied force and the response of the fluid (Rodriguez, 1989). Shear viscosity is defined as:

τ=shear stress=f/A

Γ=rate of shear=u/y

η=shear viscosity=τ/Γ

where f/A is the force per unit of area required to maintain a constant velocity gradient, u/y. Viscosity is expressed as Pascal(seconds), or centipoise (cps), where 1000 cps equals 1 Pascal(second).

Polymer Processes and Compositions

One aspect of the present invention relates to a process of separating lower molecular weight polymer molecules and byproducts from high-molecular-weight polymer molecules. The process comprises the steps of forming an aqueous two-phase system comprising the polymer and an appropriate salt in water. In such a system, a soluble salt can be added to a single phase polymer-water system to induce phase separation to yield a high salt, low polymer bottom phase, and a low salt, high polymer upper phase. Under carefully selected conditions lower molecular weight polymers partition preferentially into the high salt, low polymer phase.

A variety of polymers may be used in the aforementioned method of the invention. Both non-biocompatible and biocompatible polymers may be used in the subject invention, although biocompatible polymers are preferred. Both non-biodegradable and biodegradable polymers may be used in the subject invention, although biodegradable polymers are preferred. As discussed below, the choice of polymer will depend in part on a variety of physical and chemical characteristics of such polymer and the use to which such polymer may be put.

Polymers that can be fractionated using this process include, but are not limited to, polyethers, glycols, such as poly(ethylene glycol) and poly(ethylene oxide)s, polyoxyalkylene block copolymers, such as poloxamers, poloxamines, and polyoxypropylene/polyoxybutylene copolymers, and other polyols, such as polyvinyl alcohol. The average molecular weight of these polymers may range from about 800 to greater than 100,000 daltons.

The poloxamers are a series of block copolymers having the general structure:

HO(C₂H₄O)ₐ(C₃H₆O)_{b}(C₂H₄O)ₐH

The average molecular weights of the poloxamers may range from about 1,000 to greater than 16,000 daltons. Because the ploxamers are products of a sequential series of reactions, the molecular weights of the individual poloxamer molecules form a statistical distribution about the average molecular weight. In addition, commercially available poloxamers contain substantial amounts of poly(oxyethylene) homopolymer and poly(oxyethylene)/poly(oxypropylene di-block polymers. The relative amounts of these byproducts increase as the molecular weights of the component blocks of the poloxamer increase. Depending upon the manufacturer, these byproducts may constitute from about 15% to about 50% of the total mass of the polymer. The process of the present invention exploits the differences in size and polarity, and, therefore, solubility, among the poloxamer molecules, the poly(oxyethylene) homopolymer and the poly(oxyethylene)/poly(oxypropylene) di-block byproducts. The polar fraction of the poloxamer, which generally includes the lower molecular weight fraction and the byproducts, may be removed allowing the higher molecular weight fraction of poloxamer to be recovered. The larger molecular weight poloxamer recovered by this method has physical characteristics substantially different from the starting material or commercially available poloxamer, including a higher average molecular weight, lower polydispersity and a higher viscosity in aqueous solution.

The poloxamines are tetra-functional block copolymers synthesized by the sequential addition of propylene oxide, and then ethylene oxide to the nitrogens of ethylenediaamine. The poloxamines have the following general structure:

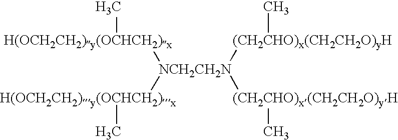

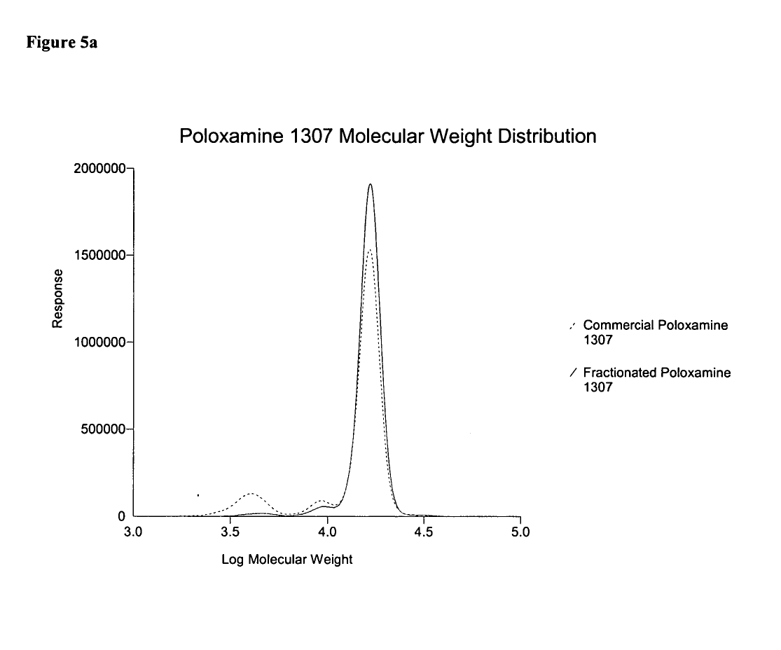

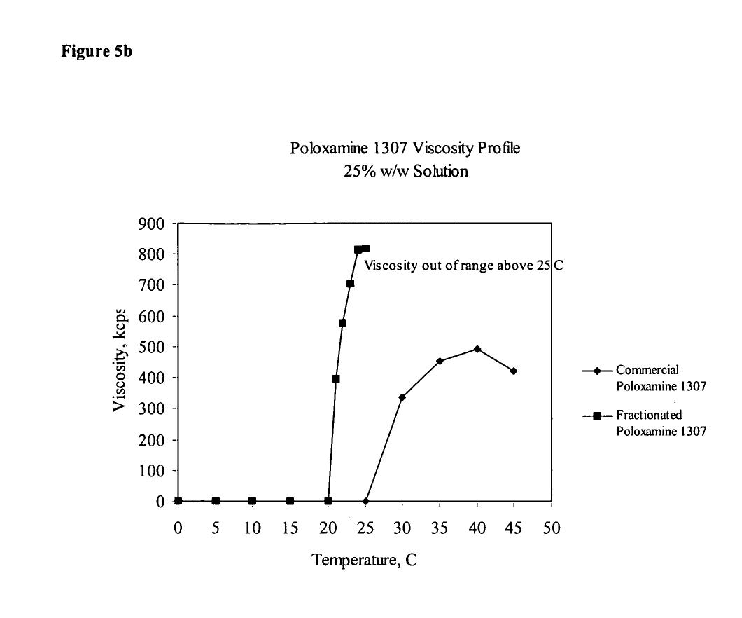

Like the poloxamers, the poloxamines are composed of molecules that vary considerably in molecular weight. When subjected to gel-permeation chromatography, commercially available poloxamine (Tetronic® 1307 purchased from BASF Corp., Mount Olive, N.J.) eluted as three separate peaks (FIG. 5a). Using a process of the present invention, much of the lower molecular weight material was removed, producing a polymer with a slightly higher average molecular weight and more uniform size compared to the starting material. In addition, the viscosities of aqueous solutions of the fractionated polymer were considerably higher than those of the commercially available material.

Because they are composed of hydrophobic poly(oxypropylene) blocks and hydrophilic poly(oxyethylene) blocks, both poloxamers and poloxamines form micelles in aqueous solutions. If the concentration of the polymer is sufficient, the micelles aggregate in a characteristic, temperature-dependent fashion, causing the solution to become a hydrogel. Such hydrogels have been used in various medical applications, including localized, organ-specific drug-delivery and manipulation of tissue during and after surgery (Reeve, L. E., “The Poloxamers: Their Chemistry and Medical Applications,” in Handbook of Biodegradable Polymers, 1997, 231-249, editors Domb, Kost, and Wiseman, Harwood Academic Publishers). Of particular interest are poloxamer 407, 338, 288, 188, and poloxamine 1107 and 1307 because, for these polymers, the transition from liquid to gel takes place below 37° C. Therefore, in medical applications, a formulation containing these polymers may be applied to the human body as a liquid at or below room temperature that will coat and adhere to tissues, but will rapidly form a gel as it warms to body temperature, and remain where it is placed for a period of time. However, commercially available poloxamers and poloxamines, gelation occurs over a broad temperature range of about 10 to about 20° C. In contrast, for fractionated polymers prepared according to a process of the present invention, the transition from liquid to gel occurred in a much narrower, well-defined temperature range of about 2 to about 5° C. In addition, the viscosities of gels of various concentrations of either fractionated polymer were higher above 30° C. These two characteristics of the fractionated polymers, rapid transition from liquid to gel over a narrow temperature range, and higher viscosity at body temperature, provide an improved gel for medical applications. Lower concentrations of the fractionated polymer can be used to provide a reliable formulation that will rapidly become a gel at a well defined temperature, but with reduced exposure to the polymer for the patient.

In one embodiment, a process of purifying polymers comprises the steps of:

1. A known amount of the polymer to be purified or fractionated is dissolved in water at an appropriate concentration.

2. The mixture is equilibrated to about 0 to about 10° C., then a soluble extraction salt is added slowly with vigorous mixing until the solution becomes opaque.

3. The solution is allowed to equilibrate at between about 0 and about 10° C. until two distinct phases, upper and lower, appear (usually between about 2 and about 8 hours). Centrifugation may be used to expedite phase separation.

4. The lower layer is removed. The upper layer is diluted to its original volume by the addition of deionized water.

5. Steps 2,3, and 4 are repeated from about 2 to about 5 times depending upon the polymer used as the starting material, the contaminating byproducts and the degree of fractionation required.

6. After the final extraction, the upper layer containing the fractionate of the polymer may the isolated and/or concentrated by extraction into dichloromethane, chloroform or any other suitable organic solvent or solvent mixture, or by dialysis. If organic extraction is used, the extract may be dried using a suitable agent such as anhydrous sodium sulfate.

7. Residual solvent(s) can be removed by vacuum or lyophilization.

8. The higher molecular weight fraction of the polymer is the dried residue obtained after removal of the solvent.

In the case of the poloxamers and the poloxamines, the fractionated polymer has a reduced polydispersity index, reduced unsaturation and increased viscosity in aqueous solution compared to the starting material, which allows for better functionality for various medical and pharmaceutical applications.

In certain embodiments, the block copolymers have molecular weights ranging from about 2000 to about 1,000,000 daltons, more particularly at least about 10,000 daltons, and even more specifically at least about 25,000 daltons or even at least about 50,000 daltons. In a preferred embodiment, the block copolymers have a molecular weight between about 5,000 daltons and about 30,000 daltons. Number-average molecular weight (Mn) may also vary, but will generally fall in the range of about 1,000 to about 400,000 daltons, preferably from about 1,000 to about 100,000 daltons and, even more preferably, from about 1,000 to about 70,000 daltons. Most preferably, Mn varies between about 5,000 and about 300,000 daltons.

In other embodiments, the polymer composition of the invention may be a flexible or flowable material. By “flowable” is meant the ability to assume, over time, the shape of the space containing it at body temperature. This characteristic includes, for example, liquid compositions that are capable of being sprayed into a site; injected with a manually operated syringe fitted with, for example, a 23-gauge needle; or delivered through a catheter.

Also encompassed by the term “flowable” are highly viscous, gel-like materials at room temperature that may be delivered to the desired site by pouring, squeezing from a tube, or being injected with any one of the commercially available power injection devices that provide injection pressures greater than would be exerted by manual means alone. When the polymer used is itself flowable, the polymer composition of the invention, even when viscous, need not include a biocompatible solvent to be flowable, although trace or residual amounts of biocompatible solvents may be present.

In certain embodiments, the subject polymers are soluble in one or more common organic solvents, thereby rendering them easily fabricated and processed. Common organic solvents include chloroform, dichloromethane, dichloroethane, 2-butanone, butyl acetate, ethyl butyrate, acetone, ethyl acetate, dimethylacetamide, N-methyl pyrrolidone, dimethylformamide, and dimethylsulfoxide.

Salts

The present invention uses salts to create a biphasic aqueous medium where one phase comprises polymers with higher molecular weights and the other phase comprises lower molecular weight polymers. In the broadest sense, the salts that may be used to prepare the polymers of the present invention comprise any chemical compound formed by replacing all or part of the hydrogen ions of an acid with metal ions or electropositive radicals. In other words, a salt is a compound comprising a cation and an anion.

In certain embodiments, salts may include salts of sulfate, phosphate or citrate. In a further embodiment, salts are sulfates, such as ammonium sulfate ((NH₄)₂SO₄).

Buffers, acids and bases may be incorporated in the subject compositions to adjust their pH. Agents to increase the diffusion distance of agents released from a subject composition may also be included.

Kits

This invention also provides kits for conveniently and effectively implementing the methods of this invention. Such kits comprise any of the block copolymers of the present invention or a combination thereof, and a means for facilitating their use consistent with methods of this invention. Such kits provide a convenient and effective means for assuring that the methods are practiced in an effective manner. The compliance means of such kits includes any means which facilitates practicing a method of this invention. Such compliance means include instructions, packaging, and dispensing means, and combinations thereof. Kit components may be packaged for either manual or partially or wholly automated practice of the foregoing methods. In other embodiments involving kits, this invention contemplates a kit including block copolymers of the present invention, and optionally instructions for their use.

Exemplification

The invention now being generally described, it will be more readily understood by reference to the following examples, which are included merely for purposes of illustration of certain aspects and embodiments of the present invention, and are not intended to limit the invention.

### EXAMPLE 1

Poloxamer 338 (75 grams; BASF Corporation, Mount Olive, N.J., lot number WPAY635B), was dissolved in 1.5 liters of DI water. The solution was maintained at approximately 7° C., and 220.5 grams of ammonium sulfate were added gradually. The solution turned opaque, and was maintained at approximately 7° C. overnight. Two distinct phases formed. The upper phase was isolated and extracted three times with methylene chloride. The methylene chloride extracts were combined and magnesium sulfate was added to remove remaining trace amounts of water. After 60 minutes, the solution was filtered to remove the magnesium sulfate. The magnesium sulfate was washed once with methylene chloride, and the methylene chloride wash was combined with the combined methylene chloride extracts. The methylene chloride was removed under vacuum at approximately 30° C. The solution became foamy. The temperature of the solution was reduced to approximately 4° C. and maintained for 30 minutes. The hardened material was recovered, and placed in a 37° C. oven to remove traces of solvent. A total of 34.9 grams of fractionated poloxamer 338 were recovered.

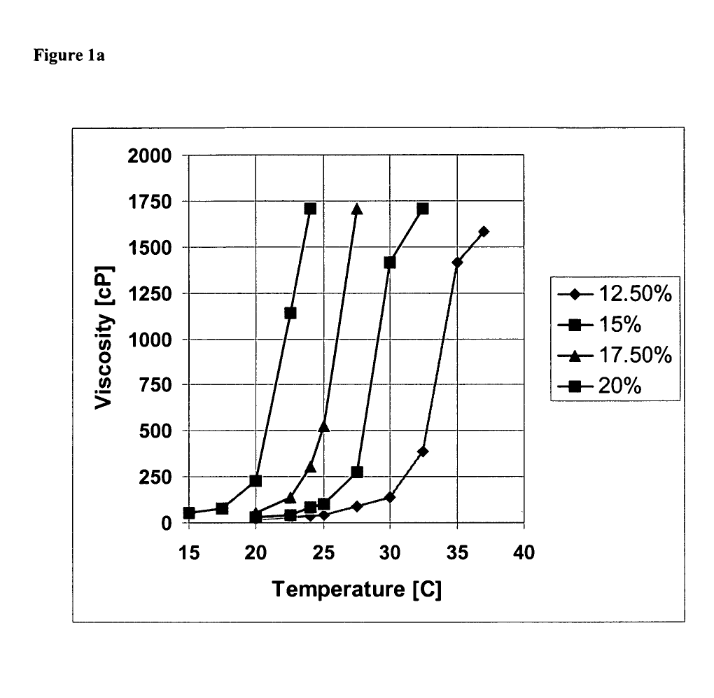

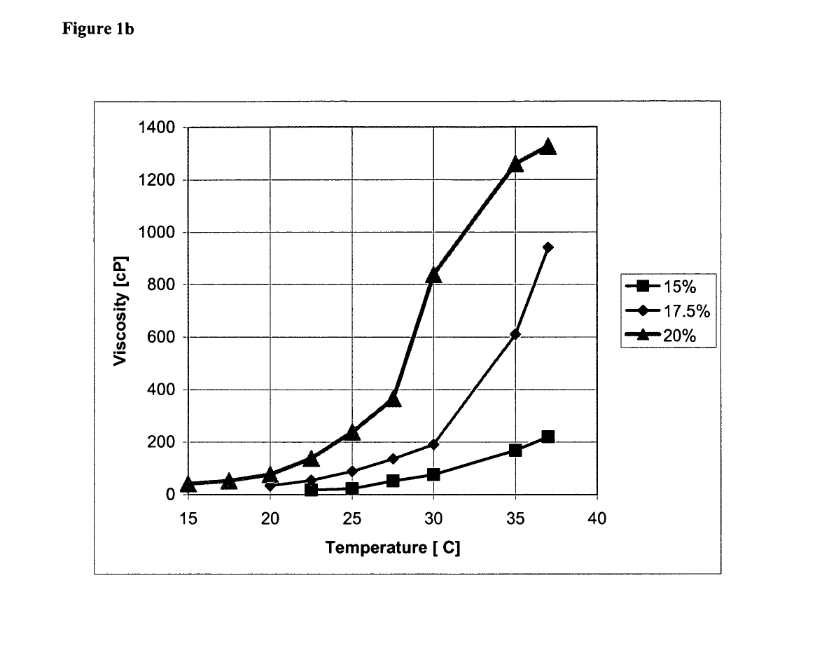

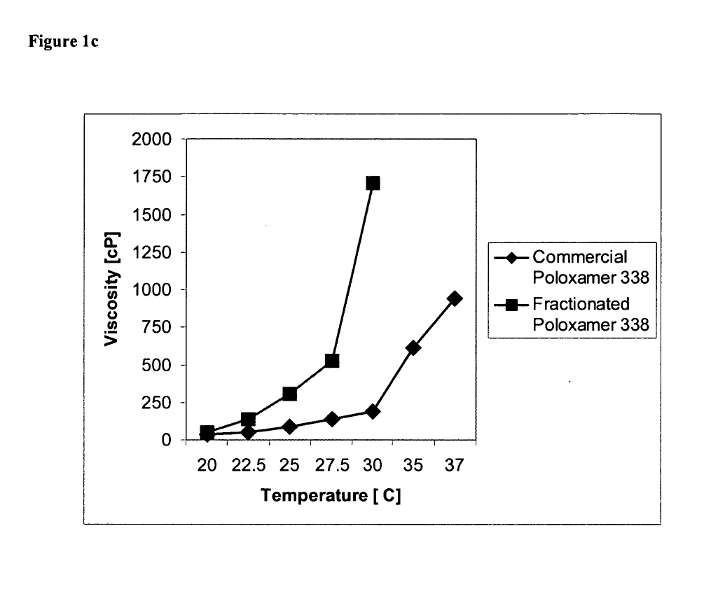

Solutions of the fractionated poloxamer 338 was prepared, and the viscosities of the solutions were compared to the viscosities of solutions of commercial poloxamer 338 from the same batch at the same weight percentages. The resulting viscosity profiles are presented in FIG. 1a, FIG. 1b and FIG. 1c.

### EXAMPLE 2

Poloxamer 407 (486.0 g, lot number WPHT-543B), purchased from BASF Corporation, Mount Olive, N.J., was dissolved in deionized water (15,733 g). The solution was maintained at 0.1° C. and 2335.1 g of (NH₄)₂SO₄ were added. The solution was equilibrated at 2° C. and after two distinct phases formed, the lower phase was discarded, and the upper phase (2060 g) was collected and weighed. Deionized water (14159 g) was added and the solution was equilibrated to 2° C. Next, 2171.6 g of (NH₄)₂SO₄ were added with stirring. After the salt was dissolved, the solution was maintained at approximately 2° C. until two phases formed. The upper phase (3340 g) was isolated and diluted with 12879 g of deionized water. The solution was chilled to about 2.2° C. and 2062 g of (NH₄)₂SO₄ were added. The phases were allowed to separate as above. The upper phase was isolated and extracted with 4 liters of dichloromethane. Two phases were allowed to form overnight. The organic (lower) phase was isolated and approximately 2 kg of sodium sulfate (Na₂SO₄) were added to it to remove the remaining water. The dichloromethane phase was filtered through a PTFE filter (0.45 μm pore size) to remove the undissolved salts. The dichloromethane was removed under vacuum at approximately 30° C. Final traces of dichloromethane were removed by drying in an oven overnight at about 30° C. A total of 297.6 g of fractionated poloxamer 407 (lot number 00115001) were recovered. The chemical and physical characteristics of the fractionated poloxamer 407 are compared to those of the starting material in Table 1.

TABLE 1

| | | | | Unsaturation | Weight % | Viscosity, |
|---|---|---|---|---|---|---|
| Sample | M_{w} | Mₙ | M_{w}/Mₙ | MEq/g | oxyethylene | centipoise* |
| Poloxamer 407 | 11,996 | 9,979 | 1.20 | 0.048 | 73.2 | 275,000 |
| Poloxamer 407, lot | 13,551 | 12,775 | 1.06 | 0.005 | 69.3 | >820,000 |
| 00115001, fractionated | | | | | | |

*Viscosity of a 25% solution measured at 30° C. using a cone and plate viscometer.

### EXAMPLE 3

Poloxamer 188 (4.5 g, BASF Corp. Lot # WPMO-568B) was dissolved in deionized water (145.5 g). The solution was cooled to 2° C. and 26.0 g (NH₄)₂SO₄ were added and dissolved with stirring. The solution was maintained at approximately 2° C. until the phases separated. After two phases formed, the lower phase was discarded, and the upper phase was diluted with 125.4 g with deionized water. The solution was cooled to 0.3° C. and 20.7 g of (NH₄)₂SO₄ were added slowly with stirring until the solution turned opaque. The solution was maintained at 3° C. until two phases formed. After the phases separated, the upper phase was isolated and diluted with 125.4 g with deionized water, chilled to −0.4° C. and 21.9 g of (NH₄)₂SO₄ were added to the solution and dissolved with stirring. The solution turned opaque, and was then maintained at 3° C. until two clear phases formed. The lower phase was removed, and the upper phase was diluted with 25 mL deionized water. The diluted solution was then extracted three times with 15 mL portions of dichloromethane. The dichloromethane extracts were combined and washed two times with 25 mL portions of deionized water. The water extracts were discarded. The dichloromethane extract was dried by filtering through anhydrous Na₂SO₄, and then the solvent was removed under vacuum at 30° C. The remaining solid material was the fractionated poloxamer 188. The fractionated poloxamer 188 was weighed (1.35 g), assigned lot number 01199001, and its physical properties were evaluated.

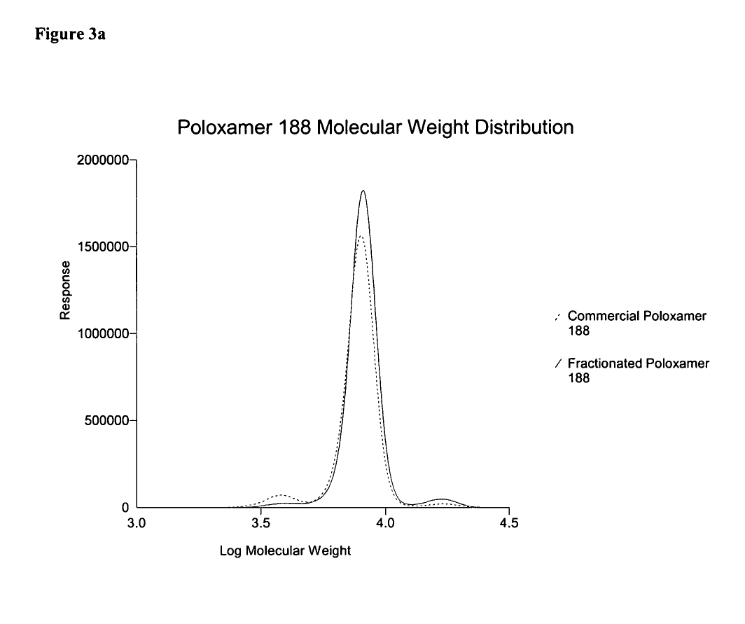

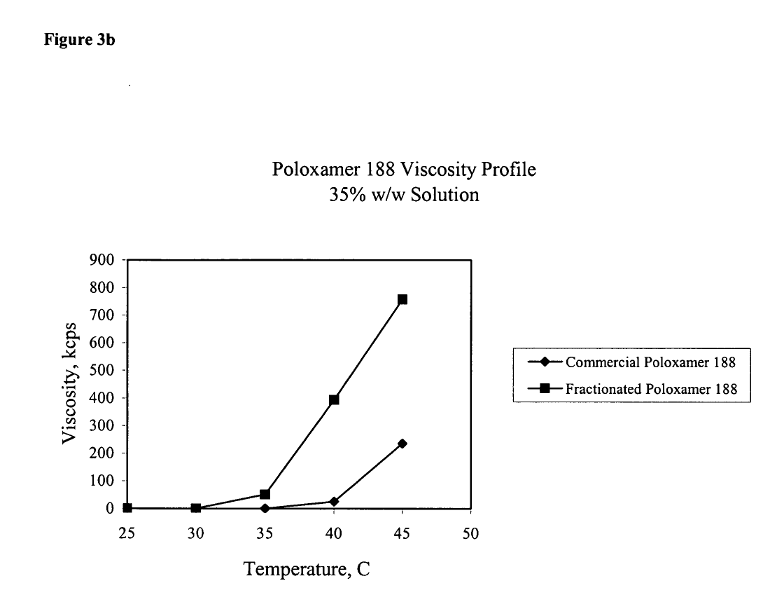

The low-molecular-weight material was removed from the fractionated poloxamer 188 (FIG. 3A) and the polydispersity index was reduced from 1.062 for the unfractionated poloxamer 188 to 1.041. The average molecular weight increased from 7,802 to 8,212. The viscosity of a 35% w/w aqueous solution of fractionated poloxamer 188 began to increase above 35° C., and formed a gel at (and above) 40° C. In contrast, a 35% solution of commercially available poloxamer 188 exhibited an increase in viscosity only above 40° C., and formed a weak gel at approximately 45° C. (FIG. 3b).

### EXAMPLE 4

Poloxamer 288 (75.0 g, BASF Lot # WPDY637C) was dissolved in 1.5 L of sterile water at approximately 7° C. To this was added gradually 211 gram of ammonium sulfate until the solution became opaque. The solution was maintained at approximately 4° C. for 5 hours, during which time, the solution separated into two phases. The upper phase was separated from the lower phase and extracted three times with methylene chloride. The organic phases were combined and magnesium sulfate was added to remove remaining trace amounts of water. After 30 min, the solution was filtered to remove the magnesium sulfate. The magnesium sulfate was washed once with methylene chloride, and the methylene chloride wash was combined with the combined methylene chloride extracts. The methylene chloride was evaporated under vacuum at approximately 30° C. and was raised to 55° C. after which most of the methylene chloride evaporated. The solution became foamy. The flask was placed into the fridge for 30 minutes and the hardened material was placed into an evaporation bowl and placed in a 37° C. oven to remove traces of solvent. A total of 32.1 gram of fractionated poloxamer 288 was recovered.

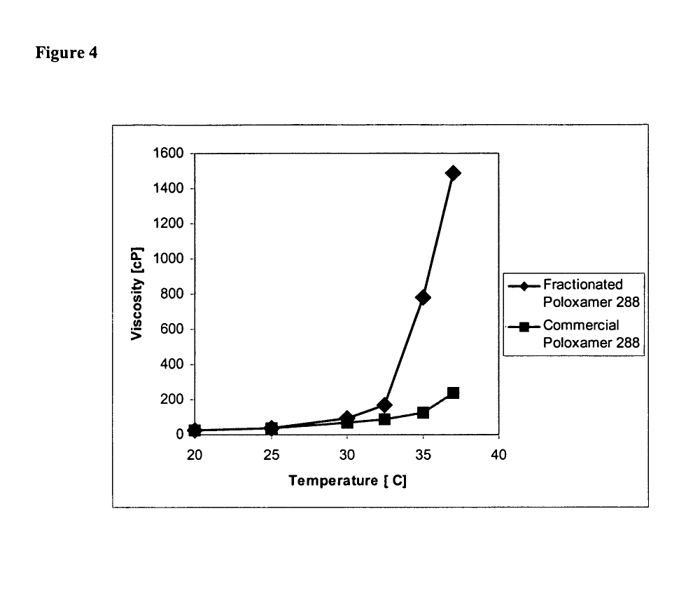

Solutions (17.5% w/w) of the fractionated poloxamer 288 and commercially available starting material from the same batch of poloxamer 288 were prepared, and the viscosities of the solutions were compared over a temperature range between 20° C. and 37° C. The resulting viscosity profiles are presented in FIG. 4.

### EXAMPLE 5

Poloxamer 238 (75.0 g, BASF Lot # WPWY612B) was dissolved in 1.5 L of sterile water at approximately 7° C. To this was added gradually 201.5 gram of ammonium sulfate until the solution became opaque. The solution was maintained at approximately 4° C. for three hours, during which time, the solution separated into two phases. The upper phase was separated from the lower phase and extracted three times with methylene chloride. The organic phases were combined and the methylene chloride was evaporated under vacuum. Acetone was added and evaporated at a temperature of 35° C. A viscous solution was recovered and maintained at 4° C. overnight. A solid, whitish material was recovered and maintained at 37° C. until the solvents were removed. A total of 43.6 g of fractionated poloxamer 238 was recovered.

### EXAMPLE 6

Poloxamine 1307 (0.45 g, BASF Corp, Mount Olive, N.J., Tetronic 1307® Lot No. WPET-587B) was dissolved in 15 g deionized water with stirring. The solution was chilled to 1.5° C., and 2.28 g (NH₄)₂SO₄ were slowly added. The solution was maintained at 2° C. until two phases formed. The lower phase was removed, 12.8 g of deionized water were added, and the solution was cooled to 0.6° C. Next, 2.0 g (NH₄)₂SO₄ were added slowly with stirring. The solution was then maintained at 2° C. without stirring until two phases formed. The lower phase was removed, 12.7 g of deionized water were added, and the solution was cooled to 1.4° C. (NH₄)₂SO₄ (2.1 g) was added slowly, with stirring until the solution turned opaque. The solution was maintained at 2° C. until two phases formed.

The upper phase was isolated and transferred to a separatory funnel with the addition of 30 mL of deionized water. The upper phase was then extracted three times with 10 mL portions of dichloromethane. The dichloromethane extracts were combined, and the solvent was removed under vacuum at 20° C. The resulting solid material (0.19 g) was the fractionated poloxamine.

The average molecular weight of the fractionated polymer was 16,217 and the polydispersity index was 1.064, compared to an average molecular weight of 14,409 and a polydispersity index of 1.316 for the commercial poloxamine, Tetronic® 1307. A 25% w/w aqueous solution of fractionated poloxamine 1307 changed from a liquid to a very stiff gel (viscosity greater than 800 kcps) between 20 and 24° C. In contrast the viscosity of a 25% solution of commercially available starting material from the same batch of poloxamine 1307 began to increase only above 25° C., and formed a non-flowable gel above about 30° C. The maximum viscosity was 494 kcps, and occurred at 40° C. (FIG. 5b).

### EXAMPLE 7

Poloxamine 1107 (50.0 grams, BASF lot# WPOW600B) was dissolved in 1 liter of water at a temperature of approximately 4° C. Next, 205 grams of ammonium sulfate were slowly dissolved in the solution, and it became opaque. The solution was maintained at approximately 6° C. Two phases formed within three hours. The upper phase was separated and diluted to 1.5 L with chilled water. Ammonium sulfate (205 grams) were added slowly until the solution became opaque again. The solution was maintained at 4° C. overnight. The upper layer was separated and extracted three times with methylene chloride (total volume approximately 250 mL). The methylene chloride extracts were combined, and the methylene chloride was evaporated and replaced by 150 mL acetone and again evaporated. The solution solidified at 4° C. within 3 hours, and the material was placed in a crystallization bowl and maintained at 37° C. until it came to a constant weight. A total of 25.7 grams of fractionated poloxamine were recovered.

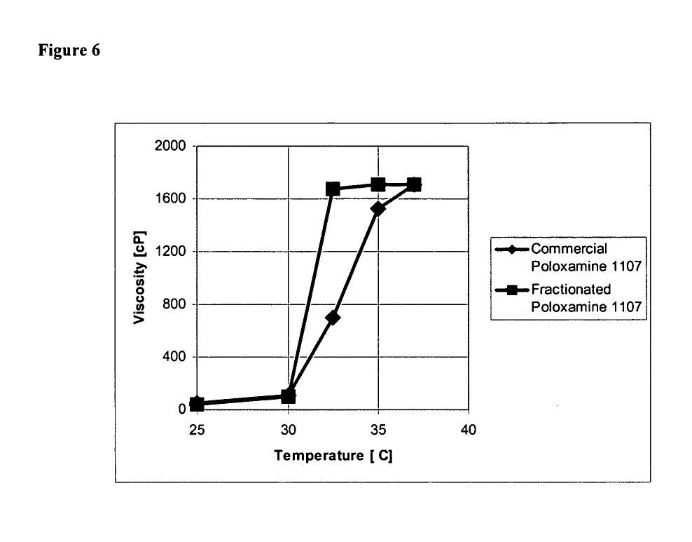

Aqueous solutions (20% w/w) of fractionated poloxamine and commercially available starting material from the same batch of poloxamine were prepared and their viscosities were compared over a temperature range of 25 to 37° C. The viscosity profiles of the solutions are presented in FIG. 6.

### EXAMPLE 8

Poloxamine 908 (50 grams, BASF Lot# WPMX592B) was dissolved in 1 L of water at 6° C. The poloxamine 908 dissolved within 15 minutes. 200 grams of ammonium sulfate were added slowly over a 5 minute period. The solution became turbid, and was stirred for 30 minutes and then placed into a 2 L separatory funnel and maintained at 4° C. After approximately two hours, two phases formed and the lower phase was removed. The upper phase was placed in a chilled 2L beaker, and the separatory funnel was repeatedly washed with a total of 1 L of chilled water, which was added to the chilled beaker. The beaker was placed in an ice bath and 200 grams of ammonium sulfate were added slowly over a 5 minute period, and the turbid solution was stirred for 30 minutes. The solution was placed into a 2 L separation funnel; two phases developed over 2.5 hours. The lower phase was discarded and the upper phase was placed in a chilled 2 L beaker. The separatory funnel was washed repeatedly with a total of 1 L of chilled water, which was added to the solution in the beaker. The solution was placed in an ice bath and 200 grams of ammonium sulfate were added over a 5 minute period, and the solution was stirred for 30 minutes. The solution was transferred to a 2 L separatory funnel and within 2 hours, two phases formed. The upper phase was placed in a 1 L separatory funnel extracted three times with 100 mL methylene chloride. The aliquots of methylene chloride were combined, and dried over anhydrous magnesium sulfate. The solution was filtered and the methylene chloride was removed under vacuum. A viscous solution was recovered and diluted with 200 mL acetone. The acetone was removed under vacuum, and the polymer crystallized. The polymer was dried overnight in a 37° C. oven to yield 22.2 grams of fractionated poloxamine 908.

### EXAMPLE 9

A 4 L jacketed Morton reactor with side draining tube (Chemglass, N.J.) was charged with 3 liters of cold DI water. A 5 L circulating heater/cooler waterbath was set to 6° C. and the water temperature inside the reactor was periodically checked until the temperature reached 6° C. 150 grams of poloxamer 338 were added in small portions and the polymer dissolved in about 30 minutes. A total of 398 grams of ammonium sulfate were added in small portions until the solution turned opaque. The stirring was continued for 30 minutes and then stopped. A two-phase systems developed within five hours.

The lower phase was drained off and 2.45 L of cold DI water was added. The solution was cooled back to 6° C. and a total of 348 grams of ammonium sulfate were added in small portions until the solution became opaque. The opaque solution was stirred for an additional 30 minutes and after 16 hours two phases were seen with the upper phase gel-like. The lower phase was removed and 2.7 L of cold DI water were added to the reactor. The gel-like upper phase went back into a clear solution. 370 grams of ammonium sulfate were added in small portions until the solution became opaque again. The opaque solution was stirred for an additional 30 minutes and the two phases separated overnight. The lower phase was removed and the 500 mL of cold DI water were added to the upper phase to dissolve the gel-like upper phase. The clear solution was drained into a beaker and the reactor was washed repeatedly with small volumes of DI water.

The combined solutions (total approximately 1.4 L) were transferred into a 4 L separation funnel and 250 mL methylene chloride was added. The separation funnel was shaken repeatedly and then the different solvents separated. The lower organic phase was collected in an evaporation flask and the procedure repeated twice more. The combined organic phase in the evaporation flask was placed on a rotary evaporator and the methylene chloride evaporated under vacuum and a bath temperature of 35° C. After the evaporation ended, the viscous solution was taken up in 300 mL acetone and again evaporated on the rotary evaporator. The resulting white polymer was placed into an evaporation bowl and placed into a 37° C. oven to remove traces of remaining organic solvent. Yield: 49 grams (32.7%).

Incorporation by Reference

All of the patents and publications cited herein are hereby incorporated by reference.

Equivalents

Those skilled in the art will recognize, or be able to ascertain using no more than routine experimentation, many equivalents to the specific embodiments of the invention described herein. Such equivalents are intended to be encompassed by the following claims.

We claim:

1. A polyoxyalkylene block copolymer, wherein the polyoxyalkylene block copolymer transforms from a liquid to a gel over a temperature range of about 2° C. to about 5° C.

2. The polyoxyalkylene block copolymer of claim 1, wherein the polyoxyalkylene block copolymer transforms from a liquid to a gel over a temperature range of about 2° C. to about 3° C.

3. The polyoxyalkylene block copolymer of claim 1, wherein the polyoxyalkylene block copolymer transforms from a liquid to a gel over a temperature range of about 2° C.

4. The polyoxyalkylene block copolymer of claim 1, wherein the polyoxyalkylene block copolymer transforms from a liquid to a gel below about 37° C.

5. The polyoxyalkylene block copolymer of any of claims 1-4, wherein the polyoxyalkylene block copolymer has an average molecular weight of about 3,000 daltons to about 100,000 daltons.

6. The polyoxyalkylene block copolymer of any of claims 1-4, wherein the polyoxyalkylene block copolymer has an average molecular weight of about 5,000 daltons to about 30,000 daltons.

7. The polyoxyalkylene block copolymer of any of claims 1-4, wherein the polyoxyalkylene block copolymer is selected from the group consisting of poloxamers and poloxamines.

8. The polyoxyalkylene block copolymer of any of claims 1-4, wherein the polyoxyalkylene block copolymer is a poloxamer.

9. The polyoxyalkylene block copolymer of any of claims 1-4, wherein the polyoxyalkylene block copolymer is poloxamer 407, poloxamer 338, poloxamer 288 or poloxamer 188.

10. The polyoxyalkylene block copolymer of any of claims 1-4, wherein the polyoxyalkylene block copolymer is a poloxamine.

11. The polyoxyalkylene block copolymer of any of claims 1-4, wherein the polyoxyalkylene block copolymer is poloxamine 1107 or poloxamine 1307.

12. A polyoxyalkylene block copolymer, wherein the viscosity of an aqueous solution of the polyoxyalkylene block copolymer increases by at least a factor of two over a temperature range of about 2° C.

13. The polyoxyalkylene block copolymer of claim 12, wherein the polyoxyalkylene block copolymer has an average molecular weight of about 3,000 daltons to about 100,000 daltons.

14. The polyoxyalkylene block copolymer of claim 12, wherein the polyoxyalkylene block copolymer has an average molecular weight of about 5,000 daltons to about 30,000 daltons.

15. The polyoxyalkylene block copolymer of any of claims 12-14, wherein the polyoxyalkylene block copolymer is selected from the group consisting of poloxamers and poloxamines.

16. The polyoxyalkylene block copolymer of any of claims 12-14, wherein the polyoxyalkylene block copolymer is a poloxamer.

17. The polyoxyalkylene block copolymer of any of claims 12-14, wherein the polyoxyalkylene block copolymer is poloxamer 407, poloxamer 338, poloxamer 288 or poloxamer 188.

18. The polyoxyalkylene block copolymer of any of claims 12-14, wherein the polyoxyalkylene block copolymer is a poloxamine.

19. The polyoxyalkylene block copolymer of any of claims 12-14, wherein the polyoxyalkylene block copolymer is poloxamine 1107 or poloxamine 1307.

20. A kit comprising the polyoxyalkylene block copolymer of claim 1 or 12; and instructions for use thereof.
